(19) United States
(12) Patent Application Publication
(10) Pub. No.: US 2006/0267947 A1
(43) Pub. Date: Nov. 30, 2006

(54) Electronic apparatus provided with foldable and turnable display unit

(75) Inventors: Shigeki Nishiyama, Hino-shi (JP); Kenji Shimano, Tokyo (JP); Manabu Taga, Yokohama-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/299,396

(22) Filed: Dec. 12, 2005

(30) Foreign Application Priority Data
May 30, 2005 (JP) 2005-157349

(51) Int. Cl. G09G 5/00

(52) U.S. Cl. 345/168

(57) ABSTRACT

An electronic apparatus includes a functional portion provided at an upper surface of a main body, and a hinge portion which couples a display unit to the main body, and includes a first shaft and a second shaft. The display unit is rotatable about the first shaft to change its state between a first state in which it covers the upper surface and a second state in which it is opened to expose the upper surface. The display unit is also turnable about the second shaft with respect to the main body. Furthermore, the display unit is set in a third state in which it covers the upper surface in such a way as to expose the functional portion, when it is downwardly rotated about the first shaft after being turned about the second shaft while being in the second state.

### CROSS-REFERENCE TO RELATED APPLICATIONS

This application is based upon and claims the benefit of priority from prior Japanese Patent Application No. 2005-157349, filed May 30, 2005, the entire contents of which are incorporated herein by reference.

### BACKGROUND

1. Field

Embodiments of the present invention relate to an electronic apparatus provided with a foldable and turnable display unit.

2. Description of the Related Art

As an electronic apparatus, there is provided a personal computer which includes a display panel overlaid by a touch panel, and which has a tablet mode of operation. (Such a computer will be referred to as a tablet-mode computer). The tablet-mode computer comprises a main body, a display unit and a hinge portion which couples the display unit to the main body. In most tablet-mode computers, the hinge portion includes a rotation shaft about which the display unit can be pivoted from a closed to an open position, and a swivel shaft about which the display unit can be reversed. This kind of tablet-mode computer is disclosed in, for example, Jpn. Pat. Appln. KOKAI Publication No. 2004-53927.

The tablet-mode computer disclosed in the above publication can be used after the display unit is opened to an upright position about the rotation shaft to expose a keyboard and a display screen. Furthermore, while being kept upright, the display unit can be reversed about the swivel shaft, and then closed. Thus, the tablet-mode computer can be closed, with the screen of the display unit facing upwards. Accordingly, information can be input to the tablet-mode computer with input means such as a Pen, even after the tablet-mode computer is closed.

However, when such a conventional tablet-mode computer is closed, with the display screen facing upwards, the entire upper surface of the main body is covered by the display unit. Thus, if, for example, a fingerprint recognition portion is provided on the upper surface of the main body, it cannot be used. Nor can a speaker on the upper surface of the main body function effectively.

Furthermore, in certain tablet-mode computers, buttons including, for example, a button for changing the orientation of the display on the screen, are provided on the display unit so that the tablet-mode computer can be used, with the display unit closed.

However, the buttons provided on the display unit are limited in number, providing only a subset of desirable functions. This is because the area for the buttons is limited since they are located adjacent to the display screen. Also, the size of the display screen is limited by the presence of the buttons. Therefore, the tablet-mode computer is not easy to use, with the display unit closed and the display screen facing upwords.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary perspective view of an electronic apparatus according to a first embodiment of the present invention.

FIG. 2 is an exemplary front view of the electronic apparatus shown in FIG. 1, which shows that a display unit of the electronic apparatus is opened.

FIG. 3 is an exemplary front view of the electronic apparatus, which shows that the display unit of the electronic apparatus is reversed from the state shown in FIG. 2 while the display unit is opened.

FIG. 4 is an exemplary enlarged perspective view of a latch shown in FIG. 1.

FIG. 5 is an exemplary perspective view for showing movement of the display unit of the electronic apparatus shown in FIG. 1, in which the display unit is opened.

FIG. 6 is an exemplary perspective view for showing movement of the display unit of the electronic apparatus shown in FIG. 1, in which the display unit is closed after being reversed.

FIG. 7 is an exemplary plan view showing that the electronic apparatus shown in FIG. 1 is closed, with a display screen facing upwardly.

FIG. 8 is an exemplary plan view of an electronic apparatus according to a second embodiment of the present invention.

FIG. 9 is an exemplary perspective view of an electronic apparatus according to a third embodiment of the present invention.

FIG. 10 is an exemplary plan view showing that the display unit of the electronic apparatus shown in FIG. 9 is closed, with a display screen facing upwardly.

FIG. 11 is an exemplary perspective view of an electronic apparatus according to a fourth embodiment of the present invention.

FIG. 12 is an exemplary plan view showing that the display unit of the electronic apparatus shown in FIG. 11 is closed, with a display screen facing upwardly.

FIG. 13 is an exemplary plan view of an electronic apparatus according to a fifth embodiment of the present invention, which shows that the electronic apparatus is closed, with a display screen facing upwardly.

FIG. 14 is an exemplary plan view of an electronic apparatus according to a sixth embodiment of the present invention, which shows that the electronic apparatus is closed, with a display screen facing upwardly.

### DETAILED DESCRIPTION

Personal computers according to embodiments of the present invention will be explained with reference to the accompanying drawings.

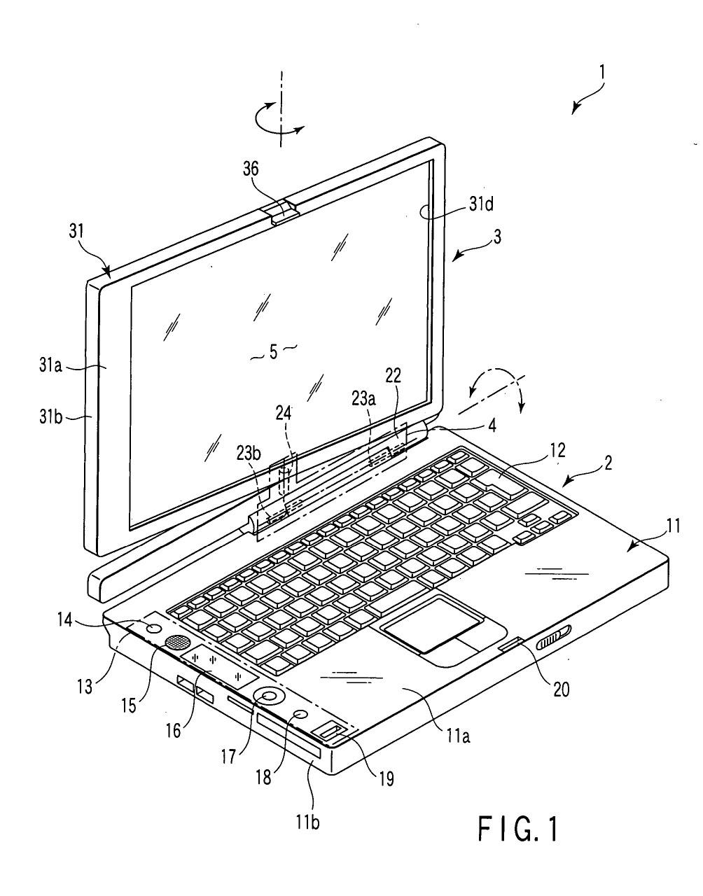

FIGS. 1 to 7 shows a personal computer 1 as an electronic apparatus according to a first embodiment of the present invention. As shown in FIG. 1, the personal computer 1 comprises a main body 2, a display unit 3 and a hinge portion 4. The hinge portion 4 couples the display unit 3 to the main body 2. The display unit 3 includes a display screen 5 at its surface.

The main body 2 is provided with a box-shaped main-body case 11. The main-body case 11 includes an upper wall 11a as an upper surface, side walls 11b and a bottom wall not shown. The upper wall 11a of the main-body case 11 supports a keyboard 12. The keyboard 12 includes a right edge which extends along a right side edge of the upper wall 11a.

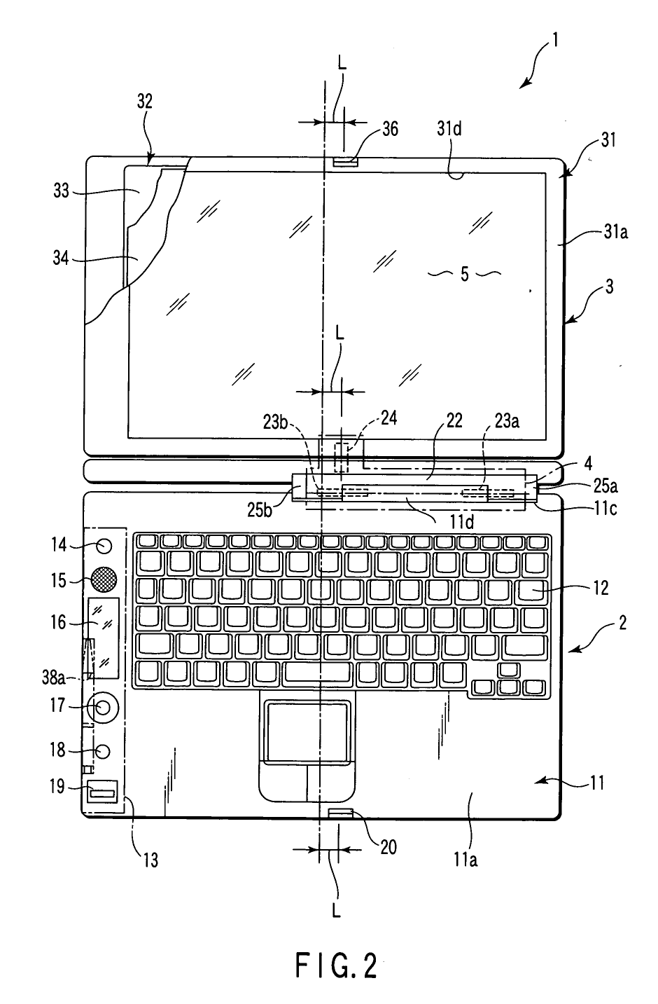

As shown in FIG. 2, at a left end portion of the upper wall 11a, an elongated functional portion 13 is provided from a rear end edge of the upper wall 11a to a front end edge thereof. At the functional portion 13, various members for causing the personal computer 1 to function are provided. For example, as the members, a power button 14, a speaker 15, a sub liquid crystal display (LCD) 16, a cursor key 17, a launcher button 18 and a fingerprint recognition portion 19 are arranged in this order from the rear side of the upper wall 11a.

The power button 14 is a button for starting up and shutting down the main body 2. The sub LCD 16 is a small liquid crystal display, and is provided to display information which supplements contents displayed on the display screen 5 of the display unit 3. The cursor key 17 is a button for use in vertically and horizontally moving a cursor displayed on the display screen 5. The launcher button 18 is a button for invoking a plurality of functions of, for example, causing an icon or icons for use in operating the personal computer 1 to appear on the display screen 5, and changing the orientation of the display on the display screen 5. The icon or the icons are an example of an object. The fingerprint recognition portion 19 has a fingerprint authentication function.

The main body 2 includes a latch receiving portion 20 as a first engagement portion at a front edge portion of the upper wall 11a. The latch receiving portion 20 is displaced rightwards from a center line of the main body 2 by a distance L in a longitudinal direction of the main body 2.

The main-body case 11 includes a step portion 11c at a right rear edge portion of the main-body case 11. Due to formation of the step portion 11c, part of the main-body case 11 which is continuous with the step portion 11c in the width direction of the main body 2 is narrower than the other parts of the main-body case 11 in the width direction of the main body 2. A supporting portion 11d projects upwardly from a center portion of the step portion 11 which is located at its center thereof in its longitudinal direction. To the supporting portion 11d, a hinge portion 4 is attached.

As shown in FIG. 2, the hinge portion 4 includes a hinge case 22, a pair of rotation shafts 23a and 23b serving as first shafts, and a swivel shaft 24 serving as a second shaft.

The hinge case 22 includes a pair of leg portions 25a and 25b which are separated from each other in the longitudinal direction of the hinge case 22. The leg portions 25a and 25b project perpendicular to the longitudinal direction of the hinge case 22. The hinge case 22 is located to extend along the main body 2 such that the supporting portion 11d is interposed between the leg portions 25a and 25b.

The axis of the rotation shaft 23a, i.e., one of the pair of the rotation shafts, is located in parallel with the upper wall 11a. One of ends of the rotation axis 23a is attached to the leg portion 25a, and the other is attached to the supporting portion 11d, such that the hinge case 22 is rotatable relative to the supporting portion 11d. Similarly, the axis of the rotation shaft 23b, i.e., the other one of the above pair of rotation shafts, is located in parallel with the upper wall 11a of the main body 2. One of ends of the rotation shaft 23b is attached to the leg portion 25b, and the other is attached to the supporting portion 11d, such that the hinge case 22 is rotatable relative to the supporting portion 11d.

By virtue of the above structure, as shown in FIG. 5, the display unit 3 is coupled to the main body 2 such that it is rotatable to change its state between a first state and a second state. The first state is a state wherein the display unit 3 is closed to cover the upper wall 11a of the main body 2. The second state is a state wherein the display unit 3 is opened, and the upper wall 11a of the main body 2 is exposed. When the display unit 3 is in the first state, it also covers the functional portion 13.

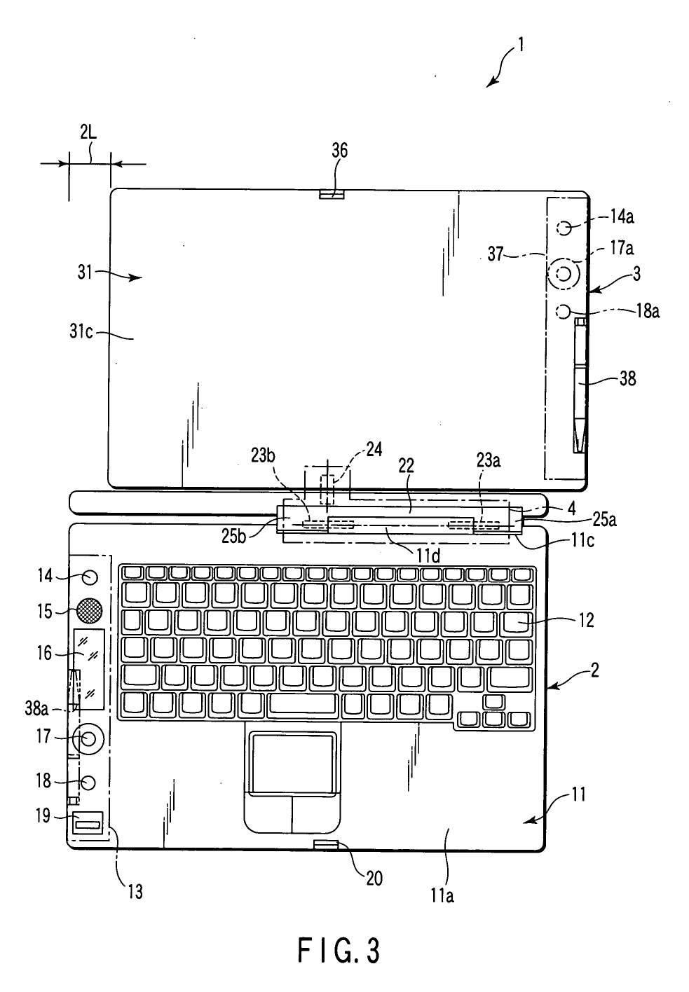

As shown in FIG. 1, the swivel shaft 24 is provided such that its axis is perpendicular to the upper wall 11a of the main body 2 when the display unit 3 is upright perpendicular to the main body 2. That is, the swivel shaft 24 is located in a direction crossing the rotation shafts 23a and 23b. As shown in FIG. 2, one of ends of the swivel shaft 24 is attached to the hinge case 22, and the other is attached to the display unit 3, such that the display unit 3 can be turned with respect to the hinge case 22. Thus, as shown in FIG. 3, the display unit 3 is turnably coupled to the main body 2. The display unit 3 can be reversed by 180°.

As shown in FIG. 2, the axis of the swivel shaft 24 is displaced rightwards from the center line of the main body 2 by the distance L in the longitudinal direction of the main body 2. The longitudinal direction is parallel to the axial direction of each of the rotation shafts 23a and 23b.

The display unit 3 comprises a housing 31 and a liquid crystal display module 32 which is accommodated in the housing 31. The housing 31 is formed in the shape of a box which has a front surface 31a, side surfaces 31b and a rear surface 31c. The front surface 31a of the housing 31 includes a display window 31d.

The liquid crystal display module 32 comprises a display panel 33 and a touch panel 34. The display panel 33 includes the display screen 5. The touch panel 34 is stacked on the display screen 5. The touch panel 34 is exposed to the outside through the display window 31d of the housing 31. The touch panel 34 is formed of transparent material.

Therefore, a user of the personal computer 1 can view the display screen 5 of the display panel 33 from the outside through the display window 31d and the touch panel 34. Furthermore, the user can directly input information to the display unit 3 by touching the touch panel 34 through the display window 31d. That is, the personal computer 1 can also serve as a tablet-mode computer.

The display unit 3 includes a latch 36 as a second engagement portion. The latch 36 is located at part of the housing 31 which is located at an upper portion thereof when the display unit 3 is in the second state, such that it is displaced rightwards from the center line of the main body 2 by the distance L in the longitudinal direction of the main body 2. That is, the latch 36 is located on the axis of the swivel shaft 24. When the latch 36 is engaged with the latch receiving portion 20, the display unit 3 is fixedly located on the main body 2.

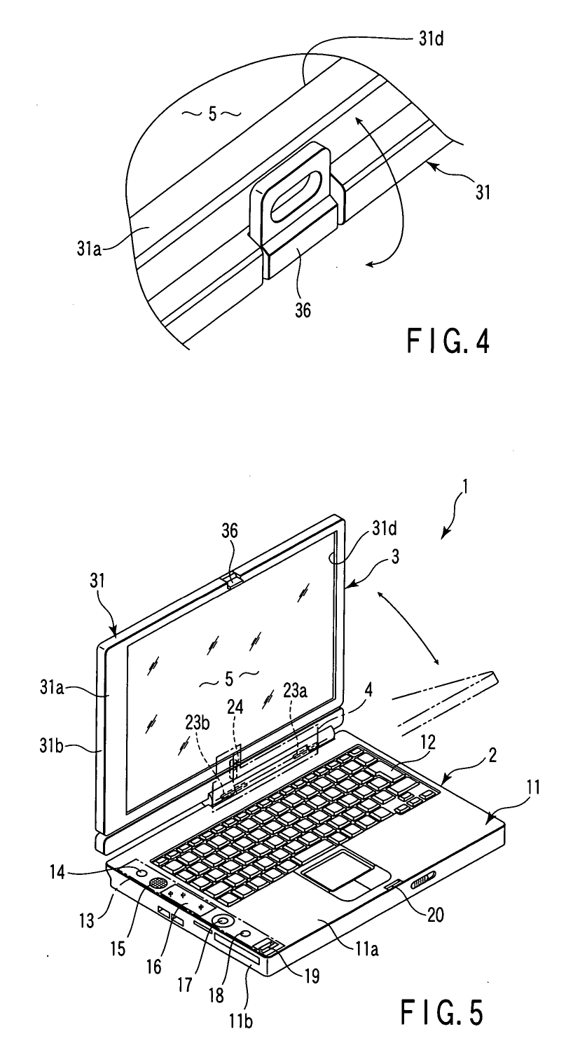

As shown in FIG. 4, at an upper edge portion of the housing 31, the latch 36 can be turned by 180° between a position in which it projects in a direction where the display screen 5 faces and a position in which it projects in a direction opposite to the direction where the display screen 5 faces. Thus, when the display unit 3 is closed, the latch 36 can be engaged with the latch receiving portion 20 regardless of whether the display unit 3 faces upwards or downwards.

At a left edge portion of the rear surface 31c of the display unit 3, i.e., an edge portion of the right side of the display unit 3 as shown in FIG. 3, an auxiliary functional portion 37 is provided as another functional portion. In the auxiliary functional portion 37, for example, a pen accommodating portion 38 for accommodating a pen for tablet mode, which is used in causing the personal computer 1 to function, is provided.

Next, the operation of the personal computer 1 will be explained.

When the personal computer 1 is not used, or it is carried, the display unit 3 is in the first state wherein it covers the upper surface of the main body 2. As shown in FIG. 2, the latch receiving portion 20 and the latch 36 are displaced rightwards from the center line of the main body 2 by the distance L in the longitudinal direction of the main body 2.

Therefore, when the display unit 3 is in the first state, the latch receiving portion 20 and the latch 36 face each other. Thus, the display unit 3 is held in the first state, since the latch receiving portion 20 and the latch 36 are engaged with each other.

When the personal computer 1 is used, the latch receiving portion 20 and the latch 36 are disengaged from each other. Then, as shown in FIG. 5, the display unit 3 is rotated about the rotation shafts 23a and 23b such that it is opened, the upper wall 11a of the main body 2 and the display screen 5 of the display unit 3 are exposed, that is, the display unit 3 is set in the second state. When the display unit 3 is in the second state, the user can operate the personal computer 1 by using the keyboard 12 and the members located at the functional portion 13, i.e., the power button 14, the cursor key 17, the launcher button 18 and the finger recognizing portion 19. Furthermore, the user can directly input information to the display screen 5 by utilizing the tablet mode of operation, and can also acquire information through the sub LCD 16 and the speaker 15.

Next, how the personal computer 1 is used when it is closed, with the display screen 5 facing upwards, will be explained.

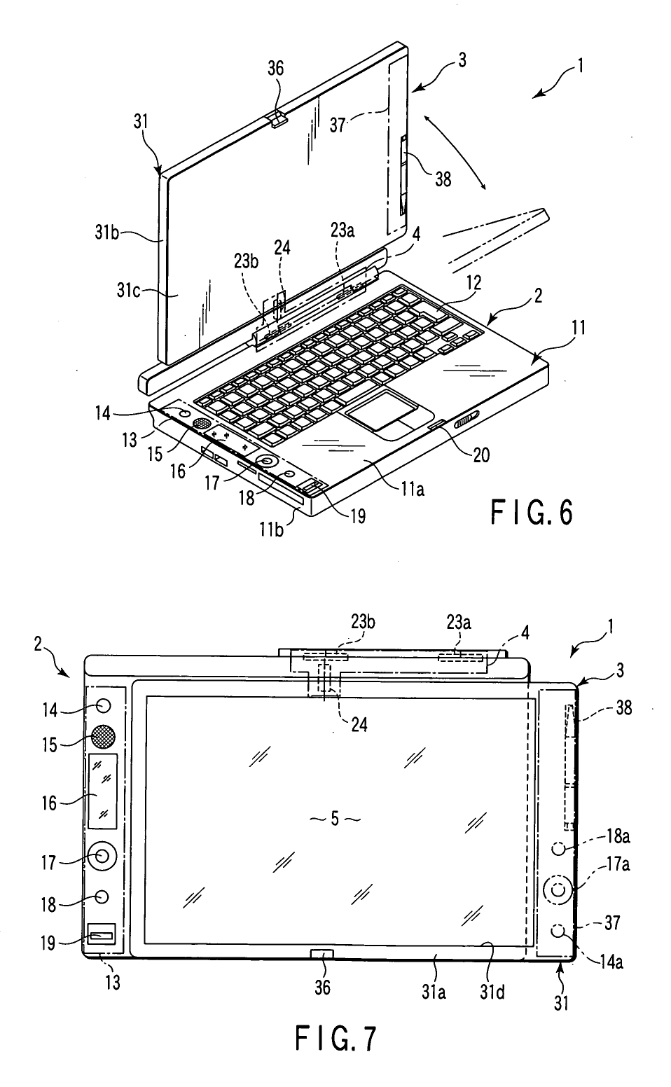

First, the display unit 3 is turned about the swivel shaft 24 by 180°, i.e., it is reversed, while it is in the second state. To be more specific, as shown in FIGS. 3 and 6, the rear surface 31c of the display unit 3 is located to face the user. The swivel shaft 24 is displaced rightwards from the center of a rear edge portion of the main body 2 by the distance L in the longitudinal direction of the main body 2. Therefore, when the display unit 3 is reversed, i.e., it is turned by 180°, as shown in FIG. 3, it is displaced rightwards from the main body 2 by a distance 2L. After or before the above reversion of the display unit 3, the latch 36 is turned by 180° as shown in FIG. 4, and is projected from the rear surface 31c of the display unit 3. In this state, when the display unit 3 is rotated downwards about the rotation shafts 23a and 23b to be closed, its state is changed to a third state wherein it covers the upper wall 11a of the main body 2 as shown in FIG. 7.

The latch 36 is located on the axis of the swivel shaft 24, when the display unit 3 is in the second state.

Therefore, even when the display unit 3 is turned about the swivel shaft 24 by 180°, the relative position of the latch 36 to the main body 2 is unchanged. Thus, when the display unit 3 is set in the third state, the latch 36 is made to face the latch receiving portion 20. That is, the latch 36 is engaged with the latch receiving portion 20, thereby holding the display unit 3 in the third state.

In the third state, the front surface 31a at which the display screen 5 is exposed is located to face upwards. Therefore, even when the display unit 3 is folded, the user can input information to the personal computer 1 by using the tablet mode of operation.

As shown in FIG. 3, in the case where the display unit 3 is turned by 180°, it is displaced rightwards from the main body 2 by the distance 2L. When the display unit 3 is changed from the state shown in FIG. 3 to the third state, as shown in FIG. 7, the functional portion 13 does not overlap the display unit 3, and the auxiliary functional portion 37 does not overlap the upper wall 11a of the main body 2, and they are exposed to the outside. Therefore, even when the display unit 3 is closed, the user can use the power button 14, the cursor key 17, the launcher button 18 and the fingerprint recognition portion 19 which are provided at the functional portion 13. In addition, the user can obtain information from the sub LCD 16 and the speaker 15, and remove the pen for tablet-mode mode from the pen accommodating portion 38 provided in the auxiliary functional portion 37, i.e., the user can use the pen.

In such a manner, in the personal computer 1 having the above structure, the power button 14, the cursor key 17 and the launcher button 18 provided at the functional portion 13 can be used, even when the display unit 3 is closed, with the display screen 5 facing upwards. That is, the above buttons and key can be used when the display unit 3 is in any of the second state and the third state. Thus, when the personal computer 1 is used, with the display unit 3 folded, it is easier to use than a conventional tablet-mode computer.

As mentioned above, the functional portion 13 is provided at the main body 2, not the display unit 3. To be more specific, in the conventional personal computer, a power button, a cursor key and a launcher button are provided at the display unit, whereas in the present invention, the power button 14, the cursor key 17 and the launcher button 18 are provided at the main body 2.

Since the area of the main body 2 in which structural elements can be provided is larger than that of the display unit 3, the speaker 15, the sub LCD 16 and the fingerprint recognition portion 19 can also be provided at the functional portion 13 in addition to the power button 14, the cursor key 17 and the launcher button 18. Thus, the usability of the personal computer 1 is further improved.

Moreover, since the power button 14, the cursor key 17, the launcher button 18 and the fingerprint recognition portion 19 are provided at the main body 2, they can be stably pushed or slid in order that they be turned on and off, as compared with the case where they are provided at the display unit 3.

As repeatedly mentioned above, since, e.g., the power button 14 and the launcher button 18 are provided at the main body 2, the display unit 3 does not need to have structural elements which have the same functions as the power button 14 and the launcher button 18. Accordingly, in the display unit 3, the display screen 5 can be made larger with respect to the size of the housing 31.

In addition, if an arbitrary one or ones of the above buttons are provided at the auxiliary functional portion 37, the area of the functional portion 13 can be reduced. Therefore, in this case, the distance by which the display unit 3 is displaced from the main body 2 when the display unit 3 is in the third state can be reduced, and at the same time the same advantage can be obtained as in the above structure.

The number of cables to be extended from the main body 2 to the display unit 3 can be decreased, since as stated above, the power button 14, the speaker 15, the sub LCD 16, the cursor key 17, the launcher button 18 and the fingerprint recognition portion 19 are provided at the main body 2, not the display unit 3. Thereby, the display unit 3 can be made more compact.

Also, as described above, the latch 36 is provided on the axis of the swivel shaft 24. Thus, even when the display unit 3 is reversed, the display unit 3 can be fixed to the main body 2 by using the above latch 36. That is, it is not necessary to provide a latch specific for the third state of the display unit 3, i.e., it is not necessary to provide another latch. Therefore, the structure of the personal computer 1 can be made simple, thus lowering the cost of the personal computer 1.

It should be noted that, for example, a pen accommodating portion 38a may be provided at the functional portion 13 as indicated by a chain double-dashed line in FIG. 2. Also, for example, a power button 14a, a cursor key 17a and a launcher button 18a may be provided at the auxiliary functional portion 37 as indicated in chain double-dashed lines in FIG. 3.

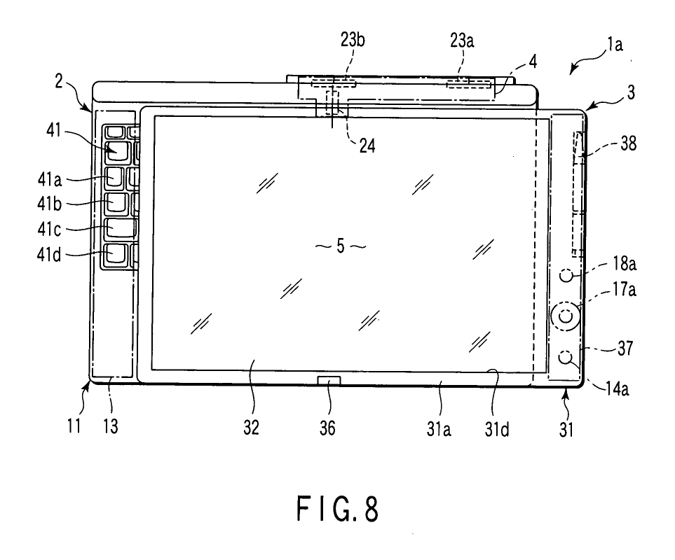

Next, a personal computer 1a which is an electronic apparatus according to a second embodiment of the present invention will be explained with reference to FIG. 8. In the personal computer 1a, the same structural members as in the personal computer 1 according to the first embodiment are denoted by the same reference numerals, respectively, and their explanation will be omitted.

FIG. 8 shows the personal computer 1a as the electronic apparatus. The upper wall 11a of the main case 11 supports a keyboard 41 which is located in such a manner as to extend from a left edge portion of the upper wall 11a to a right edge portion thereof. Keys 41a, 41b, 41c and 41d of the keys of the keyboard 41, which are located on the left side of the keyboard 41, are located at the functional portion 13. The hinge portion 4 includes the rotation shafts 23a and 23b as first shafts and the swivel shaft 24 as a second shaft as in the first embodiment. Therefore, the state of the display unit 3 can be changed from the first state to the third state as in the first embodiment.

When the display unit 3 is in the third state, the keys 41a, 41b, 41c and 41d located at the functional portion 13 are exposed to the outside. When the display unit 3 is in the second state, the keys 41a, 41b, 41c and 41d regularly function, i.e., they function as keys of the keyboard 41.

On the other hand, when the display unit 3 is in the third state, the keys 41a, 41b, 41c and 41d are set to have specific functions, i.e., they function as keys for use in operating the personal computer 1a. For example, the keys 41a, 41b, 41c and 41d are arranged in this order from the rear side, and are set to have a function of starting up and shutting down the main body 2, a function of moving the cursor displayed on the display screen 5, a function of causing an icon or icons for use in operating the personal computer 1a to be displayed on the display screen 5, a function of changing the orientation of the display screen 5, respectively.

In the personal computer 1a having the above structure, as described above, when the display unit 3 is in the third state, the keys 41a, 41b, 41c and 41d of the keyboard 41 are exposed. The keys 41a, 41b, 41c and 41d have the above specific functions. That is, even when the personal computer 1a is closed, with the display unit 5 facing upwardly, the user can operate the personal computer 1a by using the keys 41a, 41b, 41c and 41d. The above structural feature improves the usability of the personal computer 1a, specially in the case where the display unit 3 is closed.

Needless to say, in the second embodiment, the size of the display unit can be decreased, while maintaining the size of the display screen as in the first embodiment. Furthermore, the size of the display screen can be increased, while maintaining the size of the display unit.

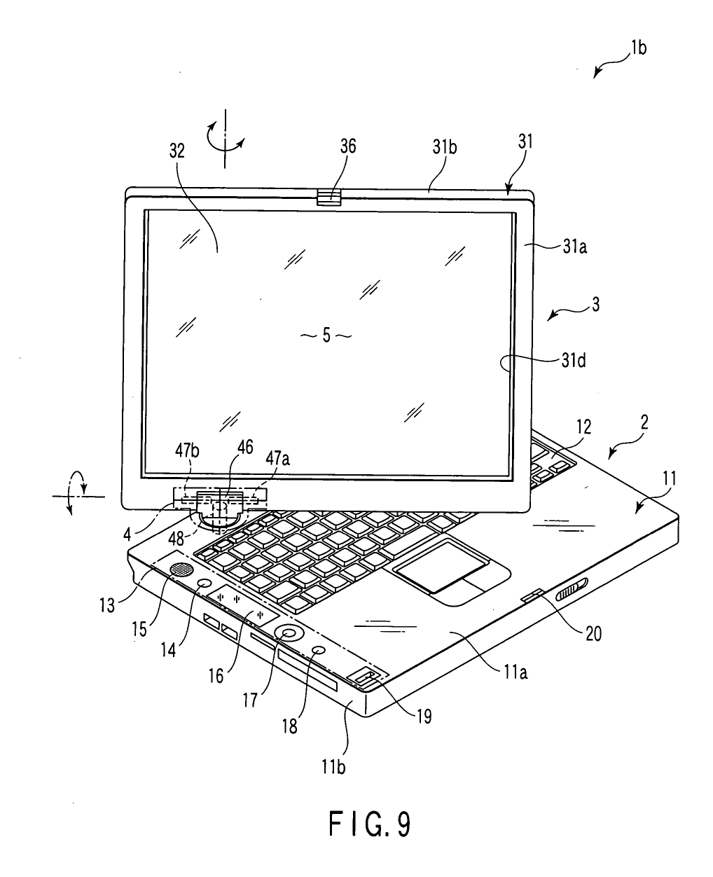

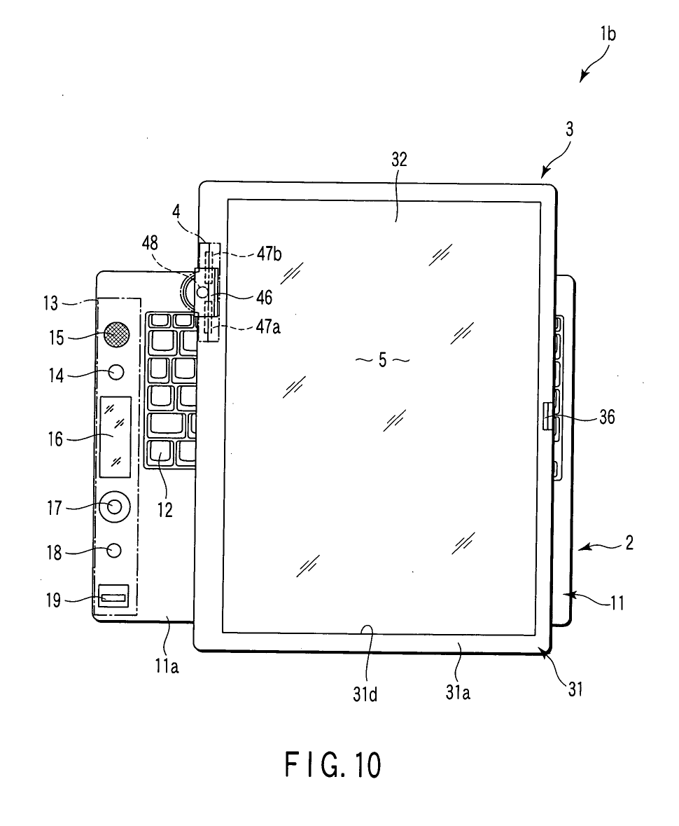

Next, a personal computer 1b as an electronic apparatus according to a third embodiment of the present invention will be explained with reference to FIGS. 9 and 10. In the third embodiment, the same structural members as in the first and second embodiments are denoted by the same reference numerals, respectively, and their explanation will be omitted.

As shown in FIG. 10, the hinge portion 4 is provided at the rear edge portion of the main body 2, and is displaced leftwards from the center line of the main body 2 in the longitudinal direction thereof. The hinge portion 4 includes a hinge case 46, a pair of rotation shafts 47a and 47b as first shafts and a swivel shaft 48 as a second shaft. The hinge case 46 is T-shaped when viewed from the front.

The axis of the swivel shaft 48 is located perpendicular to the upper wall 11a of the main body 2.

Also, the axis of the swivel shaft 48 is displaced leftwards from the center line of the main body 2 in the longitudinal direction thereof. One of ends of the swivel shaft 48 is attached to the main body 2, and the other is attached to the hinge case 46, such that the hinge case 46 is turnable with respect to the main body 2.

By virtue of the above structural feature, the display unit 3 is turnable coupled to the main body 2, and therefore, the display screen 5 can be turned.

The axes of the rotation shafts 47a and 47b are located in parallel with the upper wall 11a of the main body 2. One of ends of each of the rotation shafts 47a and 47b is attached to the hinge case 46, and the other is attached to the display unit 3, such that the display unit 3 is rotatable about the hinge case 46. That is, the swivel shaft 48 is located in a direction crossing the rotation shafts 47a and 47b.

Due to the above structure, the display unit 3 is rotatable such that its state can be changed between a first state wherein it is closed to cover the upper wall 11a of the main body 2 and a second state wherein it is opened to expose the upper wall 11a of the main body 2.

Then, the operation of the personal computer 1b will be explained.

In order that the personal computer 1b be used while the display unit 3 is in its closed state, with the display screen 5 facing upwards, the following operation is carried out: first, the display unit 3 is rotated to be opened until its state is changed to the second state, and the display unit 3 is turned about the swivel shaft 48 by 90° in a clockwise direction. In this state, when the display unit 3 is closed about the rotation shafts 47a and 47b, the state of the display unit 3 changes to a third state in which the display unit 3 covers the upper wall 11a of the main body 2 as shown in FIG. 10.

When the display unit 3 is in the third state, the front surface 31a at which display screen 5 is exposed is located to face upwardly. Therefore, even when the display unit 3 is closed, the user can input information to the personal computer 1b by using the tablet mode of operation.

As shown in FIG. 10, when the display unit 3 is in the third state, the functional portion 13 is exposed. Therefore, even when the display unit 3 is closed, the user can operate the personal computer 1b by using the power button 14, the cursor key 17, the launcher button 18 and the fingerprint recognition portion 19 which are provided at the functional portion 13. Furthermore, the user can obtain information from the sub LCD 16 and speaker 15.

In the personal computer 1b having the above structure, even in the case where the display unit 3 is turned by 90°, it can be closed, with the display screen 5 facing upwardly. Thus, even when the display unit 3 is in the third state, the personal computer 1b can be operated by using the power button 14, the speaker 15, the sub LCD 16, the cursor key 17, the launcher button 18 and the fingerprint recognition portion 19 which are provided at the functional portion 13. That is, those elements provided at the functional portion 13 can be used when the display unit 3 is in any of the second state and the third state. This structural feature can improve the usability of the personal computer 1b, specially in the case where the display unit 3 is closed.

The size of the display unit can be decreased, while maintaining the size of the display screen. The size of the display screen can be increased, while maintaining the size of the display unit as in the first embodiment.

It should be noted that in the third embodiment also, the keyboard 41 may be provided, and a number of keys of the keyboard 41, which are exposed when the display unit 3 is in the third state, may be located at the functional portion 13 of the personal computer 1b to have specific functions of operating the personal computer 1b, instead of the power button 14, the speaker 15, the sub LCC 16, the cursor key 17, the launcher button 18 and the fingerprint recognition portion 19, as in the second embodiment. Also, at the functional portion 13, the pen accommodating portion 38 may be provided.

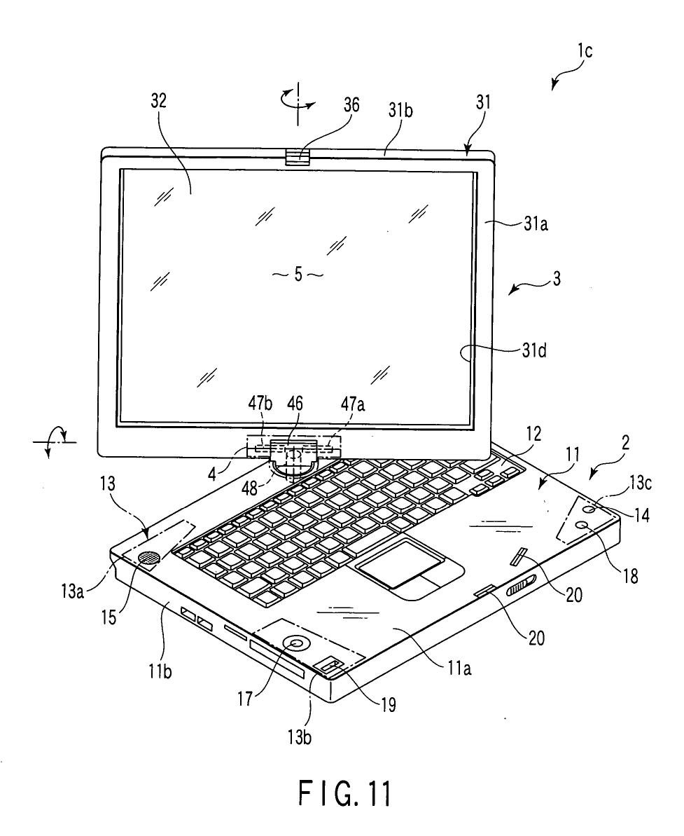

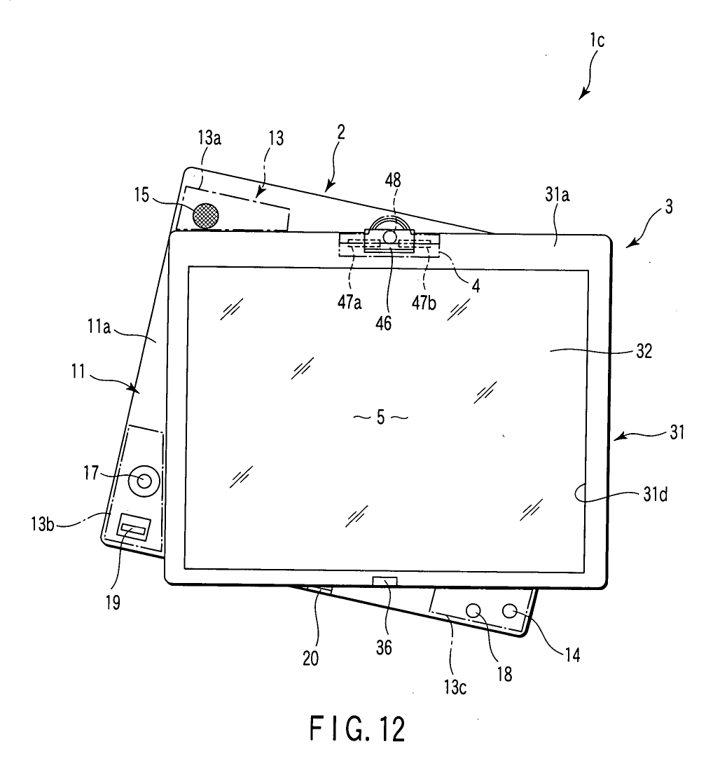

Next, a personal computer 1c as an electronic apparatus according to a fourth embodiment of the present invention will be explained with reference to FIGS. 11 and 12. In the fourth embodiment, the same structural members as in the first to third embodiments are denoted by the same reference numerals, respectively, and their explanation will be omitted.

In the fourth embodiment, the functional portion 13 is provided at the upper wall 11a of the main body 2 as shown in FIG. 11. To be more specific, the functional portion 13 is divided into a first functional portion 13a, a second functional portion 13b and a third functional portion 13c. The first functional portion 13a is located at the left rear edge portion of the main body 2, the second functional portion 13b is located at the left front edge portion of the main body 2, and the third functional portion 13c is located in the right front edge portion of the main body 2. In the first functional portion 13a, for example, the speaker 15 is provided. In the second functional portion 13b, for example, the cursor key 17 and the fingerprint recognition portion 19 are provided. In the third functional portion 13c, for example, the power button 14 and the launcher button 18 are provided.

The hinge portion 4 is located at the center of the rear edge side of the main body 2 in the longitudinal direction of the main body 2. The hinge portion 4 includes the hinge case 46, the pair of rotation shafts 47a and 47b as first shafts and the swivel shaft 48 as a second shaft as in the third embodiment. However, the swivel shaft 48 is provided such that its axis extends through the center of the rear edge side.

Then, the operation of the personal computer 1c will be explained. In the personal computer 1c, the state of the display unit 3 can be changed from the first state to the second state by using the rotation shafts 47a and 47b as in the third embodiment.

In order that the personal computer 1c be used, with the display unit 3 closed and the display screen 5 located to face upwardly, the following operation will be performed: first, the display unit 3 is rotated to be opened until its state is changed to the second state, and the display unit 3 is turned about the swivel shaft 48 by a predetermined angle, e.g., 160°, in the clockwise direction. In this state, when the display unit 3 is rotated downwards about the rotation shafts 47a and 47b, i.e., it is closed, its state changes to a third state wherein it covers the upper wall 11a of the main body 2 as shown in FIG. 12.

When the display unit 3 is in the third state, the front surface 31a at which the display screen 5 is exposed is located to face upwardly. Therefore, the user can input information to the personal computer 1c which has the tablet mode of operation, even when the display unit 3 is closed. Also, when the display unit 3 is in the third state, as shown in FIG. 12, it lies on the main body 2 such that it is displaced therefrom, and the first to third functional portions 13a, 13b and 13c are exposed. Therefore, the user can operate the personal compute 1c by using the power button 14, the cursor key 17, the launcher button 18 and the fingerprint recognition portion 19, each of which is located in any of the first to the third functional portions 13a, 13b and 13c. Furthermore, the user can obtain information from the speaker 15.

In the fourth embodiment, the user closes the display unit 3 about the rotation shafts 47a and 47b, after turning the display unit 3 by 180° about the swivel shaft 48, thereby changing the state of the display unit 3 from the second state to a fourth state in which the display unit 3 covers almost the entire upper wall 11a of the main body 2.

In the personal computer 1c having the above structure, the display unit 3 can be closed such that the display screen 5 faces upwardly, with the display unit 3 inclined by a predetermined angle. When the display unit 3 is in the third state, the personal computer 1c can be operated by using the power button 14, the speaker 15, the cursor key 17, the launcher button 18 and the fingerprint recognition portion 19, each of which is located in any of the first to the third functional portions 13a, 13b and 13c. That is, the power button 14, the speaker 15, the cursor key 17, the launcher button 18 and the fingerprint recognition portion 19, each of which is located in any of the first to the third functional portions 13a, 13b and 13c, can be used when the display unit 3 is in any of the second state and the third state. This structural feature improves the usability of the personal computer 1c, specially in the case where the display unit 3 is closed.

In the case where information is input by using the tablet mode of operation only, i.e., it is input without the need to use the above buttons and cursor, the display unit 3 can be used in the fourth state, i.e., a state wherein it lies on the main body 2 such that it is not displaced therefrom, as in the conventional tablet-mode computer. When the personal computer 1c is used, its state can be changed between the third state wherein the first to third functional portions 13a, 13b and 13c are exposed and the fourth state in which these functional portions are not exposed, accordance to the purpose of the user.

Needless to say, in the fourth embodiment also, the size of the display unit can be decreased, while maintaining the size of the display screen. The size of the display screen can be increased, while maintaining the size of the display unit as in the first embodiment.

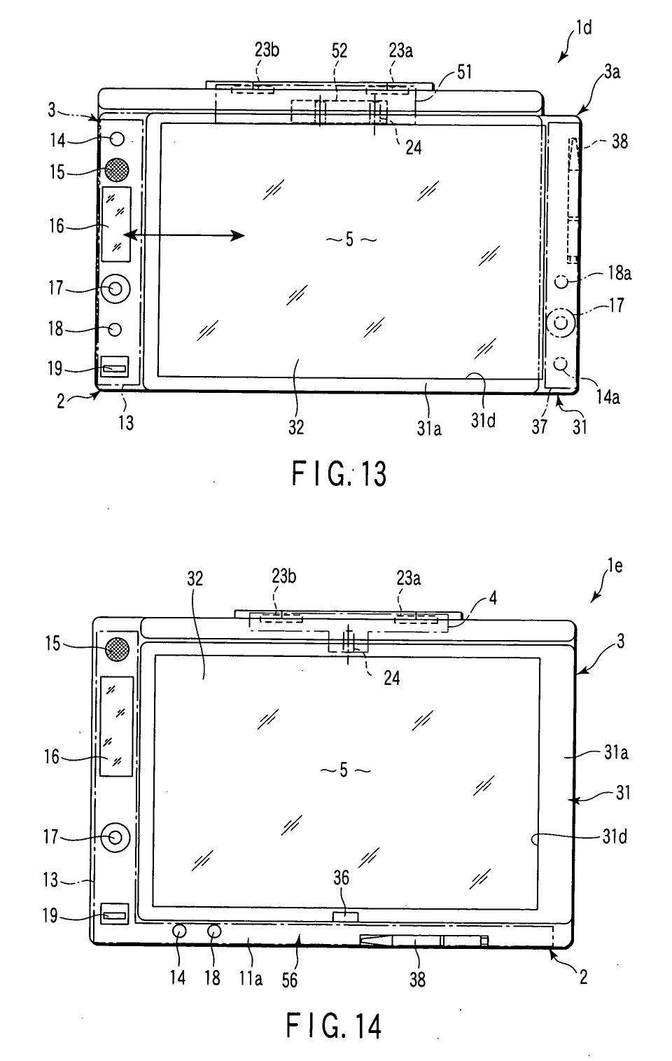

Next, a personal computer 1d as an electronic apparatus according to a fifth embodiment of the present invention will be explained with reference to FIG. 13. In the fifth embodiment, the same structural members as in the first embodiment are denoted by the same reference numerals, respectively, and their explanation will be omitted.

A hinge portion 51 couples the display unit 3 to the main body 2. As shown in FIG. 13, the hinge portion 51 includes the hinge case 22, the pair of rotation shaft 23a and 23b as first shafts, and the swivel shaft 24 as a second shaft as the first embodiment. The swivel shaft 24 is provided such that its axis extends through the center of the rear edge portion of the main body 2. Thus, the state of the display unit 3 can be changed from the first state to the second state as in the first embodiment. Furthermore, when the display unit 3 is closed about the rotation shafts 23a and 23b after reversing the display unit 3 about the swivel shaft 24, its state changes to a third state in which it covers the entire upper wall 11a of the main body 2 as indicated by a chain double-dashed line in FIG. 13.

The hinge portion 51 incorporates a mechanism 52 for sliding the display unit 3 in the longitudinal direction of the main body 2. The mechanism 52 enables the display unit 3 to be moved to the position of a display unit 3a which is indicated by a solid line in FIG. 13. When the display unit 3 is slid as shown in FIG. 13, the functional portion 13 is exposed. Therefore, even when the display unit 3 is closed, the user can operate the personal computer 1d by using the power button 14, the cursor key 17, the launcher button 18 and the fingerprint recognition portion 19 which are provided at the functional portion 13. Furthermore, the user can obtain information from the sub LCD 16 and the speaker 15.

In the personal computer 1d having the above structure, when the display unit 3 is in the third state, and then when it is slid rightwards, the functional portion 13 is exposed. That is, the power button 14, the speaker 15, the sub LCD 16, the cursor key 17, the launcher button 18 and the fingerprint recognition portion 19 provided at the functional portion 13 can be used when the display unit 3 is in any of the second state and the third state. This structural feature improves the usability of the personal computer 1d, specially in the case where the display unit 3 is closed.

In the fifth embodiment also, needless to say, the size of the display unit can be decreased, while maintaining the size of the display screen. The size of the display screen can be increased, while maintaining the size of the display unit as in the first embodiment.

Next, a personal computer 1e as an electronic apparatus according to a sixth embodiment of the present invention will be explained with reference to FIG. 14. In the sixth embodiment, the same structural members as in the first embodiment are denoted by the same reference numerals, respectively, and their explanation will be omitted.

As shown in FIG. 14, the main body 2 includes a main-body case 56 which is larger than the housing 31 of the display unit 3. When the display unit 3 is made to lie on the main body 2 such that its right side is aligned with a right side of the main body 2, a left edge portion and a front edge portion of the upper wall 11a of the main body 2 are exposed, i.e., they are not covered by the display unit 3. Thus, the functional portion 13 is L-shaped, and is provided over the exposed left edge portion and front edge portion of the upper wall 11a.

The hinge portion 4 includes the hinge case 22, the pair of rotation shafts 23a and 23b as first shafts and the swivel shaft 24 as a second shaft as in the first embodiment. The swivel shaft 24 is provided such that its axis extends through the center of the rear portion of the display unit 3. Due to this structure, the state of the display unit 3 can be changed from the first state to the second state as in the first embodiment. When the display unit 3 is closed about the rotation shafts 23a and 23b after being reversed about the swivel shaft 24, its state changed to a third state wherein it covers the upper wall 11a of the main body 2 as shown in FIG. 14.

When the display unit 3 is in the third state, the functional portion 13 is exposed. Therefore, even when the display unit 3 is closed, the user can operate the personal computer 1d by using the power button 14, the cursor key 17, the launcher button 18 and the fingerprint recognition portion 19 provided at the functional portion 13. Furthermore, the user can obtain information from the sub LCD 16 and the speaker 15, and take out the pen from the pen accommodating portion 38.

In the personal computer 1e having the above structure, when the display unit 3 is in the third state, the functional portion 13 is exposed. That is, the power button 14, the speaker 15, the sub LCD 16, the cursor key 17, the launcher button 18, the fingerprint recognition portion 19 and the pen accommodating portion 38 provided at the functional portion 13 can be used when the display unit 3 is in any of the second state and the third state. This structural feature improves the usability of the personal computer 1e, specially in the case where display unit 3 is closed.

In the sixth embodiment also, needless to say, the size of the display unit can be decreased, while maintaining the size of the display screen. The size of the display screen can be increased, while maintaining the size of the display unit as in the first embodiment.

In the sixth embodiment, the left edge portion and front edge portion of the main-body case 56 are exposed when the display unit 3 is in the third state. However, the sixth embodiment is not limited to such a structure. That is, only one of the left edge portion, front edge portion and right edge portion of the main-body case 56 may be exposed when the display unit 3 is in the third state.

The present invention is explained by referring to the personal computers 1, 1a, 1b, 1c, 1d and 1e respectively according to the first to sixth embodiments. However, it is not limited to the structures of those personal computers. For example, in the personal computers 1 and 1a according to the first and second embodiments, the swivel shaft 24 is displaced rightwards from the main body 2; however, it may be displaced leftwards from the main body 2. In the personal computer 1b according to the third embodiment, the swivel shaft 48 is displaced leftwards from the main body 2; however, it may be displaced rightwards from the main body 2. In addition, the rotation shafts 23a and 23b may be provided between the hinge case 22 and the display unit 3, and the swivel shaft 24 may be provided between the main body 2 and the hinge case 22. As described above, in all the embodiments, two rotation shafts, i.e., the rotation shafts 23a and 23b, or 47a and 47b, are provided. However, only one rotation shaft may be provided.

The present invention can be applied to any electronic apparatus provided with an openable/closable and turnable display unit. For example, it may be applied to an information terminal such as a cellular phone.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main body including an upper surface;
a display unit;
a functional portion provided at the upper surface; and
a hinge portion coupling the display unit to the main body,
wherein the hinge portion includes (i) a first shaft about which the display unit is rotatable to change a state of the display unit between a first state in which the display unit covers the upper surface of the main body and a second state in which the display unit is opened to expose the upper surface of the main body, and (ii) a second shaft which is provided to extend in a direction crossing the first shaft, and about which the display unit is turnable with respect to the main body, and when the display unit is downwardly rotated about the first shaft after being turned about the second shaft while being in the second state, the hinge portion allows the display unit to be set in a third state in which the display unit is closed to cover the upper surface of the main body in such a way as to expose the functional portion.

2. The electronic apparatus according to claim 1, wherein the display unit includes a display screen which faces upwards when the display unit is in the third state.

3. The electronic apparatus according to claim 1, wherein the display unit includes a display screen having a tablet mode of operation.

4. The electronic apparatus according to claim 1, wherein the display unit includes a display screen, and the functional portion includes at least one of a button for causing an object for use in operating the electronic apparatus to be displayed on the display screen, a button for changing orientation of display on the display screen, a button for moving a cursor displayed on the display screen, a power button for the main body, a fingerprint recognition portion, a liquid crystal display, a pen accommodating portion and a speaker.

5. The electronic apparatus according to claim 1, wherein the main body includes a keyboard including a key which is exposed when the display unit is in the third state.

6. The electronic apparatus according to claim 5, wherein the display unit includes a display screen, and the key exposed when the display unit is in the third state is set to have any of a function of causing an object for use in operating the electronic apparatus to be displayed on the display screen, a function of changing orientation of display on the display screen, a function of moving a cursor displayed on the display screen, and a function of a power button for the main body.

7. The electronic apparatus according to claim 1, wherein the display unit includes a member which is used in operating the electronic apparatus, and which faces downwardly without overlapping the main body when the display unit is in the third state.

8. An electronic apparatus comprising:
a main body including an upper surface;
a display unit;
a functional portion provided at the upper surface; and
a hinge portion coupling the display unit to the main body,
wherein the hinge portion includes (i) a first shaft about which the display unit is rotatable to change a state of the display unit between a first state in which the display unit covers the functional portion and a second state in which the display unit is opened to expose the upper surface of the main body, and (ii) a second shaft which is provided to extend in a direction crossing the first shaft, and about which the display unit is turnable with respect to the main body, and which is displaced from a center line of the main body in an axial direction of the first shaft, and when the display unit is downwardly rotated about the first shaft after being turned about the second shaft while being in the second state, the hinge portion allows the display unit to be set in a third state in which the display unit is closed to cover the upper surface of the main body in such a way as to expose the functional portion.

9. The electronic apparatus according to claim 8, wherein the main body includes a first engagement portion, and the display unit includes a second engagement portion which is located on an axis of the second shaft, and which is engagable with the first engagement portion, when the display unit is in any of the first state and the third state.

10. An electronic apparatus comprising:
a main body including an upper surface;
a display unit; and
a hinge portion coupling the display unit to the main body,
wherein the hinge portion includes (i) a first shaft about which the display unit is rotatable to change a state of the display unit between a first state in which the display unit covers the upper surface of the main body and a second state in which the display unit is opened to expose the upper surface of the main body, and (ii) a second shaft which is provided to extend in a direction crossing the first shaft, and about which the display unit is turnable with respect to the main body, and which is displaced from a center line of the main body in an axial direction of the first shaft.

11. The electronic apparatus according to claim 10,
wherein the display unit includes a display screen which faces upwards, when the display unit is downwardly rotated about the first shaft after the display unit is turned about the second shaft while being in the second state.

12. The electronic apparatus according to claim 10, wherein the display unit includes a display screen having a tablet mode of operation.

13. The electronic apparatus according to claim 10, wherein the main body includes a functional portion which is exposed, when the display unit is downwardly rotated about the first shaft to be closed after being turned about the second shaft while being in the second state, and the display unit includes a display screen, and the functional portion includes at least one of a button for causing an object for use in operating the electronic apparatus to be displayed on the display screen, a button for changing orientation of display on the display screen, a button for moving a cursor displayed on the display screen, a power button for the main body, a fingerprint recognition portion, a liquid crystal display, a pen accommodating portion and a speaker.

14. The electronic apparatus according to claim 10, wherein the main body includes a keyboard including a key which is exposed, when the display unit is downwardly rotated about the first shaft to be closed after being turned about the second shaft while being in the second state.

15. The electronic apparatus according to claim 14, wherein the display unit includes a display screen, and the key is set to have any of a function of causing an object for use in operating the electronic apparatus to be displayed on the display screen, a function of changing orientation of display on the display screen, a function of moving a cursor displayed on the display screen, and a function of a power button for the main body.

16. The electronic apparatus according to claim 10, wherein the display unit includes a member which is used in operating the electronic apparatus, and which faces downwardly without overlapping the main body, when the display unit is downwardly rotated about the first shaft to be closed after being turned about the second shaft while being in the second state.

17. The electronic apparatus according to claim 10, wherein the main body includes a first engagement portion, and the display unit includes a second engagement portion which is located on an axis of the second shaft, and which is engagable with the first engagement portion, when the display unit is in any of the first state and a third state in which the display unit is closed to cover the upper surface of the main body, the display unit being set in the third state, when the display unit is downwardly rotated about the first shaft after being turned about the second shaft while being in the second state.
